(19) United States
(12) Patent Application Publication
(10) Pub. No.: US 2009/0258733 A1
(43) Pub. Date: Oct. 15, 2009

(54) Method and device of golf aiding with a function of setting a specific-point diagram

(75) Inventors: Chun-Sam Liu, Taipei City (TW); Jau-Chang Shen, Taipei City (TW)

Correspondence Address: BACON & THOMAS, PLLC, 625 SLATERS LANE, FOURTH FLOOR, ALEXANDRIA, VA, 22314-1176, US

(73) Assignees: CHUN-SAM LIU, Taipei City (TW); JAU-CHANG SHEN, Taipei City (TW)

(21) Appl. No.: 12/289,868

(22) Filed: Nov. 6, 2008

(30) Foreign Application Priority Data
Apr. 9, 2008 (TW) 097112896

(51) Int. Cl. A63B 57/00; G01S 5/14

(52) U.S. Cl. 473/407; 473/409; 342/357.13; 342/357.08

(57) ABSTRACT

A golf aiding device with a function of setting a specific-point diagram includes a processor, a screen, an input mechanism, a memory, a GPS module, and a software program stored in the memory. The software program can achieve the following functions: displaying a golf course on the screen; displaying a plurality of specific-point diagrams from which a user can choose a specific-point diagram; and recording the current coordinates and generating a correspondence between the current coordinates and the set specific-point diagram, and displaying the set specific-point diagram on the golf course on the screen.

### BACKGROUND OF THE INVENTION

1. Field of the Invention

The present invention relates to an aiding device for helping a golf player when he/she is playing golf; more particularly, the present invention helps the golf player to record hazard positions.

2. Description of the Related Art

Currently, there are many portable devices capable of providing assistance in golf. Most of the golf-aiding portable devices are equipped with a global positioning system (GPS) module, such that the golf-aiding portable device can determine its current position all the time.

There are many applications utilizing the GPS module in the golf-aiding portable device, including two major types.

The first type of application is to display a map of a golf course. Therefore, a user can be aware of his/her current position constantly, as well as an approximate distance between the user and a putting green. It is attractive to display the map of the golf course; however, it is difficult for a conventional golf-aiding device to display coordinates of some specific points (such as a coordinate of a bunker) on the map of the golf course because each user's requests may vary.

Further, sometimes the golf course may be rearranged. For example, a hazard (such as a bunker) may be added or changed.

Therefore, there is a need to provide a method and device of golf aiding with the function of setting a specific-point diagram to mitigate and/or obviate the aforementioned problems.

### SUMMARY OF THE INVENTION

It is an object of the present invention to provide a mechanism allowing a user to easily record coordinates of some specific points, so as to provide a more useful portable device for displaying a map of a golf course.

To achieve the aforementioned object, the golf-aiding device with a function of setting a specific-point diagram comprises a processor, a screen, an input mechanism, a global positioning system (GPS) module, and a memory.

The memory is stored with a software program. The software program of the present invention comprises a golf course display interface, a specific-point setting interface, a specific-point diagram processing code, a specific-point position setting interface, and a distance calculation processing program. Because the GPS module can obtain a current coordinate position of the golf-aiding device, the current coordinate position should be constantly stored in the memory for future use. Functions of each of the aforementioned programs include:

The golf course display interface is used for displaying at least one golf course diagram on the screen.

The specific-point setting interface is used for displaying a plurality of different specific-point diagrams from which a user can choose a specific-point diagram.

The specific-point diagram processing code is used for recording the current coordinate position, generating a correspondence between the current coordinate position and the set specific-point diagram, and displaying the set specific-point diagram on the golf course diagram according to a coordinate system.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a schematic drawing showing an appearance of the present invention.

FIG. 2 is a system structural diagram of the present invention.

FIG. 3 is a flowchart of a first embodiment of the present invention.

FIG. 4 illustrates a schematic drawing of a golf course display interface according to one preferred embodiment of the present invention.

FIG. 5 illustrates a schematic drawing of a golf course display interface according to one preferred embodiment of the present invention.

FIG. 6 illustrates a schematic drawing of a specific-point position setting interface according to one preferred embodiment of the present invention.

FIG. 7 illustrates a schematic drawing of a specific-point setting interface according to one preferred embodiment of the present invention.

FIG. 8 illustrates a schematic drawing of a specific-point position setting interface according to one preferred embodiment of the present invention.

FIG. 9 illustrates a schematic drawing of a golf course display interface according to one preferred embodiment of the present invention.

FIG. 10 is a flowchart of a second embodiment of the present invention.

FIG. 11 illustrates a schematic drawing of a golf-course display interface for displaying a plurality of specific-point diagrams according to one preferred embodiment of the present invention.

### DETAILED DESCRIPTION OF THE PREFERRED EMBODIMENT

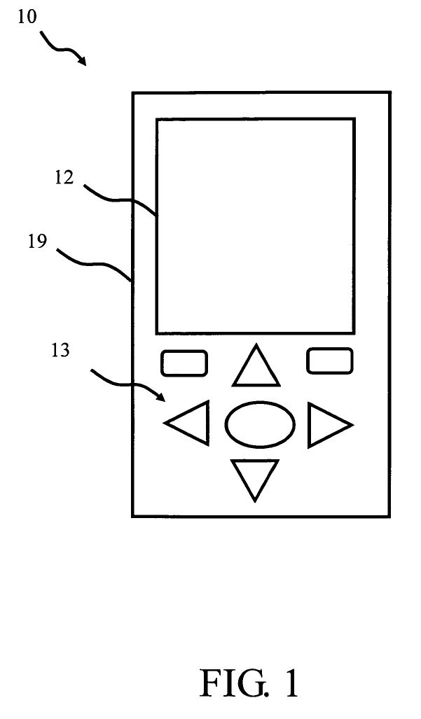

Please refer to FIG. 1, which is a schematic drawing showing an appearance of the present invention. The appearance structure of a golf-aiding device 10 with a function of setting a specific-point diagram mainly comprises a case 19. A screen 12 and an input mechanism 13 are disposed in the case 19. The input mechanism 13 includes a plurality of keys. Because the golf-aiding device 10 is equipped with a global positioning system (GPS) module, the golf-aiding device 10 comprises an antenna (not shown in FIG. 1 because the antenna of this embodiment is installed inside the case).

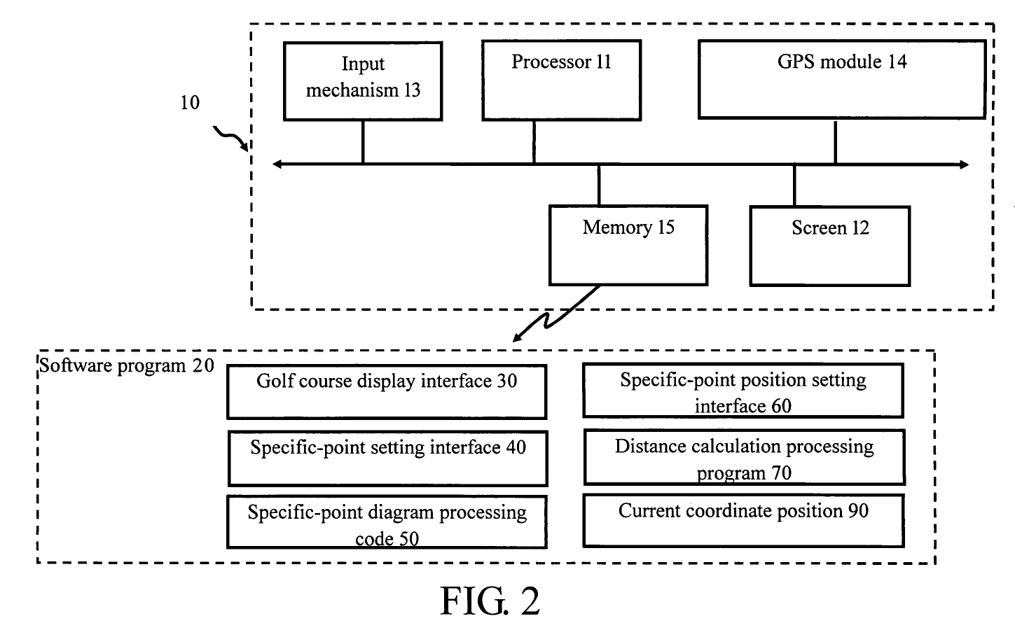

FIG. 2 is a system structural diagram of the present invention. The present invention comprises a processor 11, a memory 15 electronically connected to the processor 11, a screen 12 electronically connected to the processor 11, a GPS module 14 electronically connected to the processor 11, and an input mechanism 13 electronically connected to the processor 11. Please note that the aforementioned hardware components are general components. The GPS module 14 can obtain a current position of the golf-aiding device 10 by means of receiving a plurality of satellite signals. Because the GPS module 14 is known as a prior art, there is no need for a detailed description.

The memory 15 is stored with a software program 20, such that some specific function can be achieved after the processor 11 executes the software program 20, such as displaying information (text or diagrams) on the screen 12. The software program of the present invention mainly comprises a golf course display interface 30, a specific-point setting interface 40, a specific-point diagram processing code 50, a specific-point position setting interface 60, and a distance calculation processing program 70. Because the GPS module 14 can obtain a current coordinate position 90 of the golf-aiding device 10, the current coordinate position 90 should be constantly stored in the memory 15 for future use.

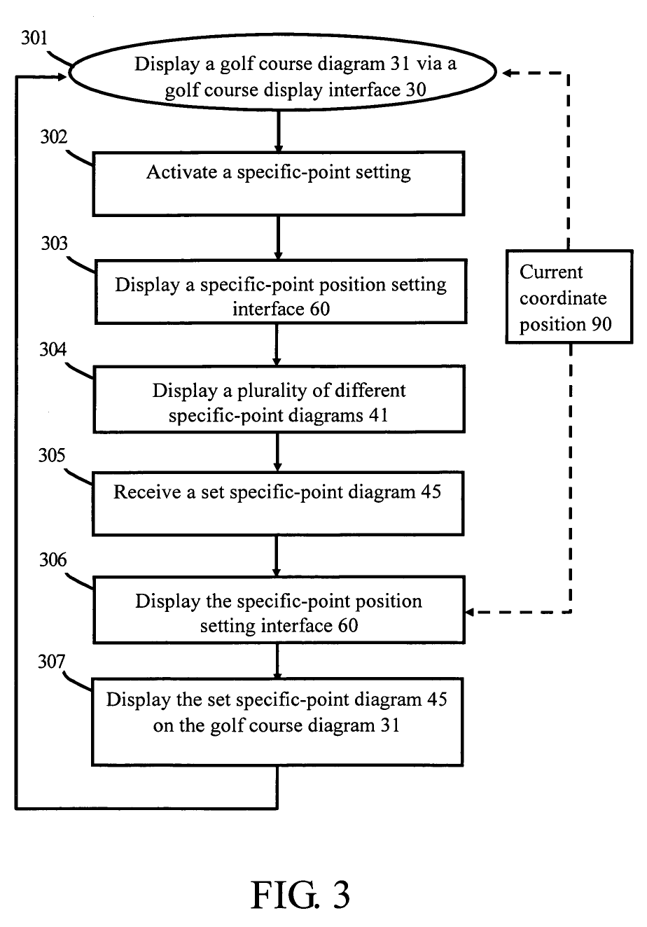

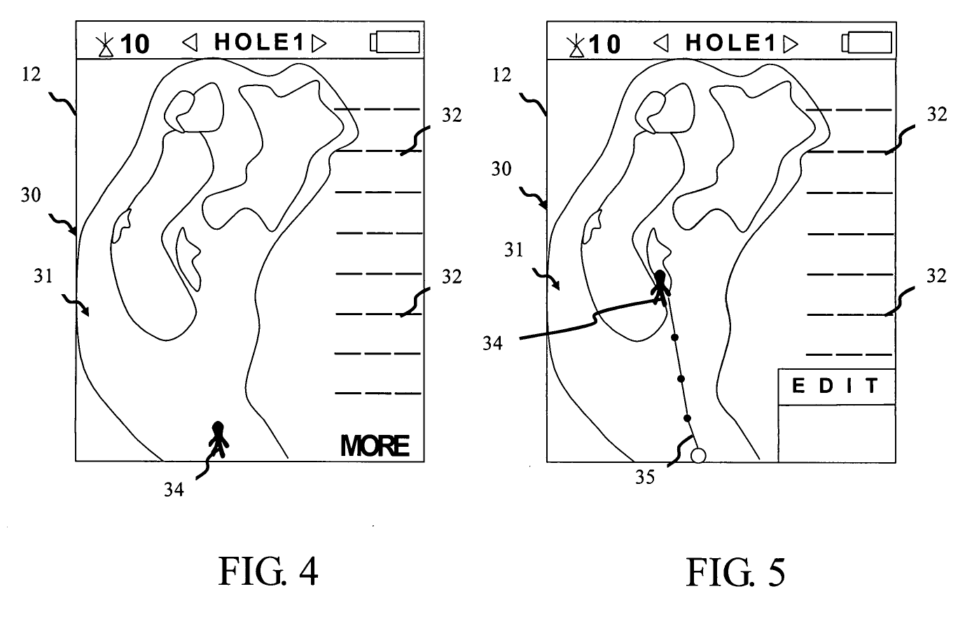

With regard to functions of the software program 20, please refer to FIG. 3 as well as to FIGS. 4˜9, wherein FIG. 3 is a flowchart of a first embodiment of the present invention, and FIGS. 4˜9 illustrate schematic drawings of related interfaces according to the preferred embodiment of the present invention.

### Step 301:

Display a golf course diagram 31 via the golf course display interface 30.

Please refer to FIG. 4. When a user is using the golf-aiding device 10, the golf course display interface 30 can be utilized to display the golf course diagram 31. It is preferable to display the golf course diagram 31 with a user mark 34 (such as a human-shaped icon), such that the user can be aware of his/her position in a golf course.

Generally, when the user is using the golf-aiding device 10, most of the time the user would probably stay with the golf course display interface 30 so that the user can observe the golf course diagram 31 and his/her position so as to gain useful information for deciding on a golf-playing strategy as well as a type of a golf club.

Please refer to FIG. 5. After the user walks on the golf course, a user walking track 35 can also be displayed.

Please note that there a plurality of golf course diagrams 31 stored in the memory 15, and the user can select a desired golf course diagram 31. Please also note that the golf course diagram 31 has corresponding coordinate positions. In order to conveniently display the golf course diagram 31 on the screen 12, the golf course diagram 31 should be processed through a shape-changing procedure (for example, expanding the width of a long and narrow golf course according to a ratio transformation). Preferably, the direction should be processed (through a direction-changing procedure), so as to make a teeing area on the bottom and a putting green on the top. Because the present invention has the GPS module 14, all of the current coordinate positions 90 of the user can be obtained. According to all of the current coordinate positions 90 and a corresponding coordinate system of the golf course diagram 31, both the user mark 34 and the user walking track 35 can be displayed on the golf course diagram 31. Because the method of calculating the user mark 34 and the user walking track 35 is known as a prior art, there is no need for a detailed description.

Moreover, the golf course display interface 30 further comprises a distance display area 32 (displayed in a right side of the screen 12). In this figure, the distance display area 32 is empty.

### Step 302:

Activate a specific-point setting.

As shown in FIG. 5, if the user is standing in front of a bunker (i.e. the position of the user mark 34 as shown in FIG. 5), and the user wants to record a coordinate of the bunker (i.e. the user wants to record the current coordinate position 90), then the user can activate the specific-point setting function by means of manipulating the input mechanism 13 (for example, pressing a certain key of the input mechanism 13).

### Step 303:

Display the specific-point position setting interface 60 on the screen 12.

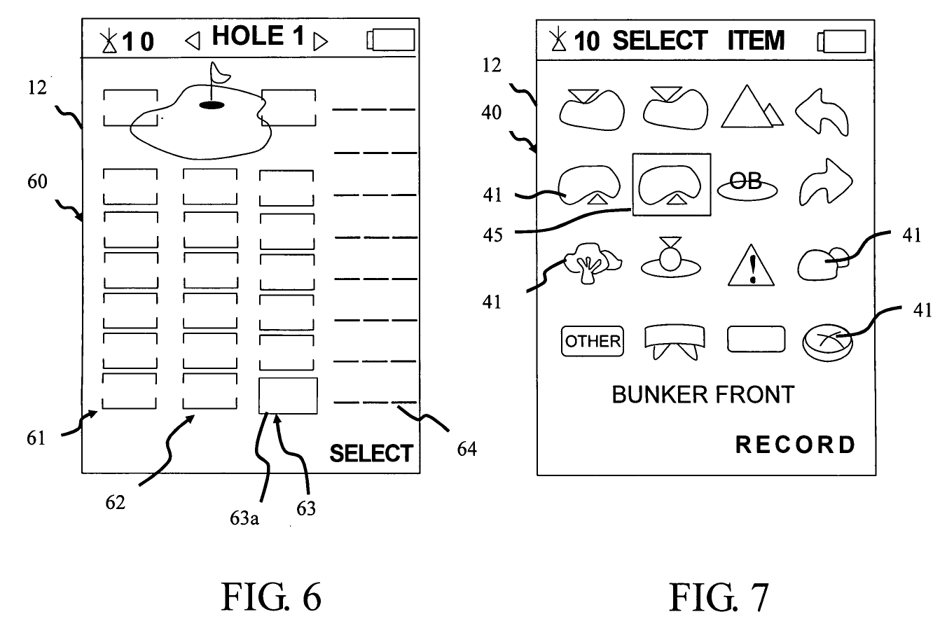

Please refer to FIG. 6. The specific-point position setting interface 60 comprises a left field 61, a center field 62, a right field 63, and a distance field 64.

The user can select a position to place a specific point by means of manipulating the input mechanism 13 (such as via a directional key set). For example, if the user wants to select the lowest position 63a of the right field 63, the user can select it by manipulating the input mechanism 13 and then pressing a “SELECT” key.

Please note that the screen 12 of this embodiment is not a touch screen, so a key-in type input mechanism 13 is essential. The screen 12 can also be a touch screen, such that the user can use a finger or a stylus to operate it. If the screen 12 is a touch screen, the screen 12 becomes a screen 12 with an input mechanism 13 (that is, the touch mechanism is the input mechanism 13).

### Step 304:

Please refer to FIG. 7. At this time, the screen 12 displays the specific-point setting interface 40, and the specific-point setting interface 40 is used for displaying a plurality of different specific-point diagrams 41. For example, in the golf course, the specific-point diagrams 41 can be trees, bunkers, or water hazards, each represented by different diagrams. For example, because the current coordinate position 90 is a bunker, the user selects a diagram representing a bunker as a user-selected specific point. This kind of diagram selected by the user would be hereinafter defined as a set specific-point diagram 45.

### Step 305:

Receive the set specific-point diagram 45.

Please refer to FIG. 7 again. After the user selects the set specific-point diagram 45 by manipulating the input mechanism 13 and presses a “RECORD” key, the software program 20 would then receive the set specific-point diagram 45.

### Step 306:

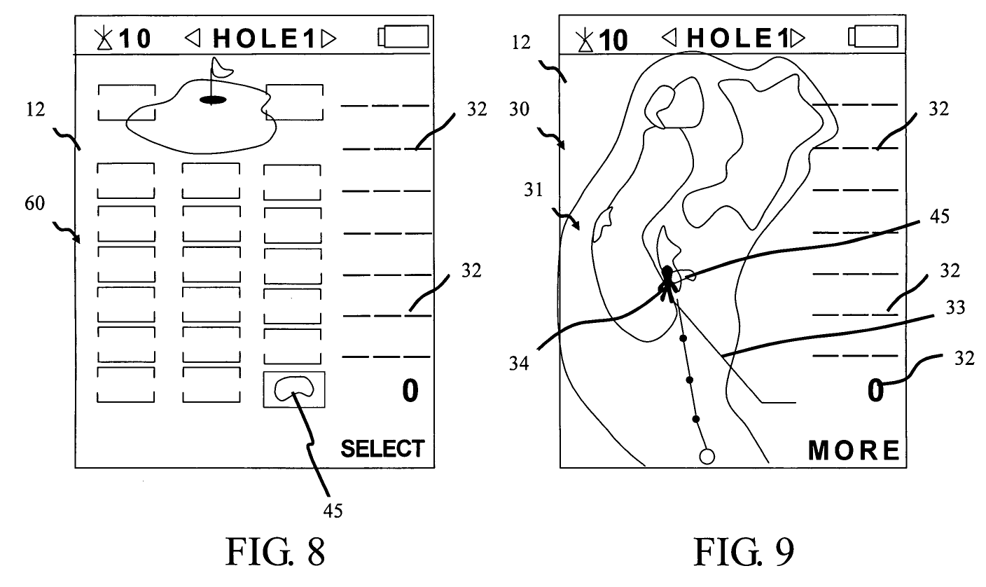

Please refer to FIG. 8. At this time, the present invention returns to the specific-point position setting interface 60, wherein the set specific-point diagram 45 is now placed in the position selected in Step 303.

Further, in Step 305 or Step 306, the specific-point diagram processing code 50 would record (such as recording in a database form) the current coordinate position 90, and generate a correspondence between the current coordinate position 90 and the set specific-point diagram 45.

After the set specific-point diagram 45 has been confirmed, the distance field 64 corresponding to the set specific-point diagram 45 would then generate a distance value. At this time, the distance value is “0”, for the current position of the user is the position of the set specific-point diagram 45, which leads to a “0” distance value. After the user leaves the position of the set specific-point diagram 45, the distance value of the distance field 64 would vary accordingly. That is, a distance calculation processing program 70 of the software program 20 would constantly calculate the distance value between the current coordinate position and the set specific-point diagram 45, and display the distance value on the corresponding distance field 64.

### Step 307:

Please refer to FIG. 9. The specific-point diagram processing code 50 displays the set specific-point diagram 45 on the golf course diagram 31 according to the coordinate system of the golf course diagram 31.

Further, the distance display area 32 corresponding to the set specific-point diagram 45 also displays the distance value between the set specific-point diagram 45 and the current coordinate position 90 (i.e. the current position of the user).

In order to help the user conveniently refer to the distance value between the set specific-point diagram 45 and the current position 90, an indication line 33 is set between the set specific-point diagram 45, and a corresponding distance value is displayed on the distance display area 32.

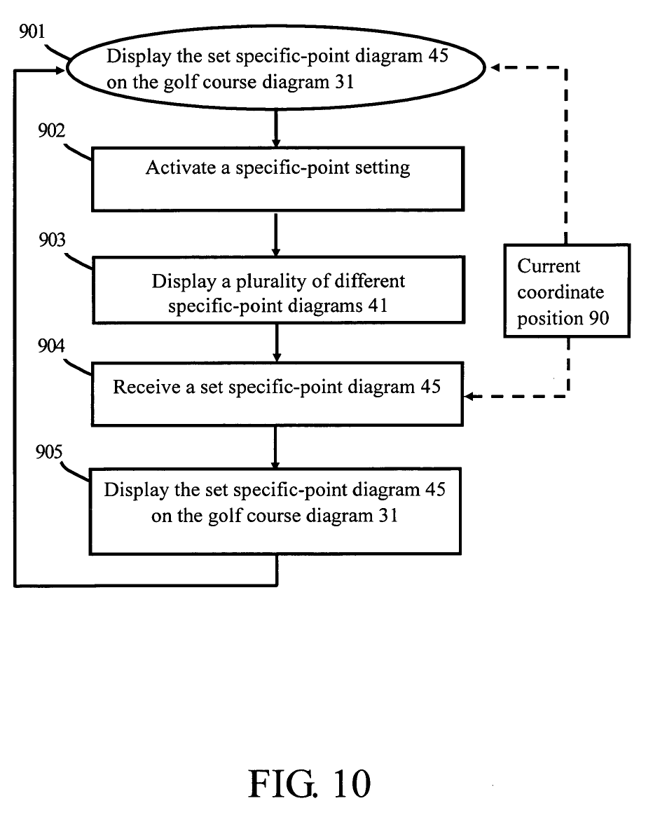

Please note that the specific-point position setting interface 60 can allow the user to browse all previously-set set specific-point diagrams 45 of a certain golf course. However, the specific-point position setting interface 60 is not necessary. Please refer to FIG. 10 as well as FIGS. 4, 5, 7, and 9, wherein FIG. 10 is a flowchart of a second embodiment of the present invention, and FIGS. 4, 5, 7, and 9 illustrate schematic drawings of related interfaces according to the preferred embodiment of the present invention.

### Step 901:

Same as Step 301. Display a golf course diagram 31 via the golf course display interface 30. Please refer to FIG. 4.

### Step 902:

Same as Step 302. Activate a specific-point setting. Please refer to FIG. 5.

### Step 903:

Same as Step 304. Please refer to FIG. 7. At this time, the screen 12 displays the specific-point setting interface 40, and the specific-point setting interface 40 is used for displaying a plurality of different specific-point diagrams 41.

### Step 904:

Same as Step 305. Receive the set specific-point diagram 45.

### Step 905:

Same as Step 307. Please refer to FIG. 9. Display the set specific-point diagram 45 on the golf course diagram 31 according to the coordinate system of the golf course diagram 31.

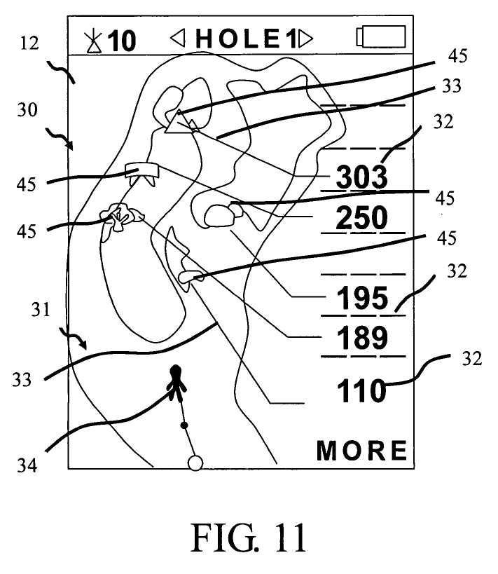

Finally, please refer to FIG. 11. According to the aforementioned steps 301˜307, or the aforementioned steps 901˜905, the user can place a plurality of specific-point diagrams on the golf course diagram 31 so as to form a user-friendly schematic drawing as shown in FIG. 11. Please note that an indication line 33 is set between each set specific-point diagram 45, and each of the corresponding distance values is displayed on the distance display area 32.

Although the present invention has been explained in relation to its preferred embodiments, it is to be understood that many other possible modifications and variations can be made without departing from the spirit and scope of the invention as hereinafter claimed.

### [FIG. 2]

11 Processor
12 Screen
13 Input mechanism
14 GPS module
15 Memory
20 Software program
30 Golf course display interface
40 Specific-point setting interface
50 Specific-point diagram processing code
60 Specific-point position setting interface
70 Distance calculation processing program
90 Current coordinate position

### [FIG. 3]

301 Display a golf course diagram 31 via a golf course display interface 30
302 Activate a specific-point setting
303 Display a specific-point position setting interface 60
304 Display a plurality of different specific-point diagrams 41
305 Receive a set specific-point diagram 45
306 Display the specific-point position setting interface 60
307 Display the set specific-point diagram 45 on the golf course diagram 31
90 Current coordinate position

### [FIG. 10]

901 Display the set specific-point diagram 45 on the golf course diagram 31
902 Activate a specific-point setting
903 Display a plurality of different specific-point diagrams 41
904 Receive a set specific-point diagram 45
905 Display the set specific-point diagram 45 on the golf course diagram 31
90 Current coordinate position

What is claimed is:

1. A golf-aiding device with a function of setting a specific-point diagram, capable of being carried by a user, the golf-aiding device with a function of setting a specific-point diagram comprising:
a processor;
a screen, electronically connected to the processor;
an input mechanism, electronically connected to the processor;
a global positioning system (GPS) module, electronically connected to the processor, used for obtaining a current coordinate position of the golf-aiding device; and
a memory, electronically connected to the processor, wherein the memory is stored with a software program, wherein the software program comprises:
a golf course display interface, used for displaying at least one golf course diagram on the screen, wherein the golf course diagram corresponds to a coordinate system;
a specific-point setting interface, used for displaying a plurality of different specific-point diagrams from which the user can choose a specific-point diagram; and
a specific-point diagram processing code, used for recording the current coordinate position and generating a correspondence between the current coordinate position and the setting specific-point diagram.

2. The golf-aiding device with a function of setting a specific-point diagram as claimed in claim 1, wherein the golf course display interface further comprises a distance display area used for displaying a distance value between the current coordinate position and the set specific-point diagram.

3. The golf-aiding device with a function of setting a specific-point diagram as claimed in claim 2, wherein the specific-point diagram processing code further displays the setting specific-point diagram on the golf course diagram according to the coordinate system.

4. The golf-aiding device with a function of setting a specific-point diagram as claimed in claim 3, wherein the distance display area is in either the left side or the right side of the golf course diagram.

5. The golf-aiding device with a function of setting a specific-point diagram as claimed in claim 4, wherein an indication line is set between each set specific-point diagram and each of the corresponding distance values is displayed on the distance display area.

6. The golf-aiding device with a function of setting a specific-point diagram as claimed in claim 5, wherein the golf course display interface is further used for displaying a user walking track.

7. The golf-aiding device with a function of setting a specific-point diagram as claimed in claim 5, wherein the software program further comprises a specific-point position setting interface, where the specific-point position setting interface comprises a left field, a center field, a right field, and a distance field, such that the user can place the set specific-point diagram in the left field, the center field, or the right field by means of manipulating the input mechanism, and the distance field can be used for displaying the distance value between the current coordinate position and the set specific-point diagram.

8. The golf-aiding device with a function of setting a specific-point diagram as claimed in claim 1, wherein the software program further comprises a specific-point position setting interface, where the specific-point position setting interface comprises a left field, a center field, a right field, and a distance field, such that the user can put the set specific-point diagram in the left field, the center field or the right field by means of manipulating the input mechanism, and the distance field can be used for displaying the distance value between the current coordinate position and the set specific-point diagram.

9. A golf-aiding method with a function of setting a specific-point diagram, used in a golf-aiding device, the method comprising:
constantly recording a current coordinate position of the golf-aiding device;
displaying at least one golf course diagram on a screen;
receiving a signal for activating a specific-point setting;
displaying a plurality of different specific-point diagrams;
receiving a set specific-point diagram, wherein the set specific-point diagram is selected from the plurality of different specific-point diagrams; and
generating a correspondence between the current coordinate position and the set specific-point diagram.

10. The golf-aiding method with a function of setting a specific-point diagram as claimed in claim 9 further comprising: displaying a distance area when displaying the golf course diagram, wherein the distance area is used for displaying a distance value between the current coordinate position and the set specific-point diagram.

11. The golf-aiding method with a function of setting a specific-point diagram as claimed in claim 10 further comprising: displaying the set specific-point diagram on the golf course diagram after receiving the set specific-point diagram.

12. The golf-aiding method with a function of setting a specific-point diagram as claimed in claim 11, wherein an indication line is set between the displayed distance value of the current coordinate position and each set specific-point diagram.

13. The golf-aiding method with a function of setting a specific-point diagram as claimed in claim 12 further comprising: displaying a user walking track when displaying the golf course diagram, wherein the user walking track is formed according to previously-recorded current coordinate positions.

14. The golf-aiding method with a function of setting a specific-point diagram as claimed in claim 13 further comprising: displaying a specific-point position setting interface, wherein the specific-point position setting interface comprises a left field, a center field, a right field, and a distance field, such that the set specific-point diagram can be placed in the left field, the center field, or the right field, and the distance field can be used for displaying the distance value between the current coordinate position and the set specific-point diagram.

15. The golf-aiding method with a function of setting a specific-point diagram as claimed in claim 9 further comprising: displaying a specific-point position setting interface, wherein the specific-point position setting interface comprises a left field, a center field, a right field, and a distance field, such that the set specific-point diagram can be placed in the left field, the center field, or the right field, and the distance field can be used for displaying the distance value between the current coordinate position and the set specific-point diagram.
